(19) United States
(12) Patent Application Publication
(10) Pub. No.: US 2024/0009966 A1
(43) Pub. Date: Jan. 11, 2024

(54) VEHICLE GLAZING ELEMENT WITH INSERT AND ASSOCIATED DEVICE WITH THERMAL IMAGING CAMERA

(71) Applicant: SAINT-GOBAIN GLASS FRANCE, COURBEVOIE (FR)

(72) Inventors: Keihann YAVARI, MARGNY-LES-COMPIEGNE (FR); Claire DAVIS, COMPIEGNE (FR)

(21) Appl. No.: 18/007,006

(22) PCT Filed: Jul. 22, 2021
(86) PCT No.: PCT/FR2021/051369

§ 371 Date: Jan. 26, 2023

(30) Foreign Application Priority Data
Jul. 30, 2020 (FR) FR2008068

(51) Int. Cl. B32B 17/10; B32B 3/26

(52) U.S. Cl. CPC B32B 17/10036; B32B 3/266; B32B 17/10293; B32B 2305/34; B32B 2307/412

(57) ABSTRACT

A vehicle glazing has a main external face to be oriented toward the outside and a main internal face to be oriented toward a passenger compartment side, the vehicle glazing including a through-hole between the internal face and the external face, which through-hole is delimited by a side wall of the vehicle glazing, the through-hole including an insert made of material that is transparent in a range A of wavelengths in the infrared spectrum beyond 2.5 μm, wherein the range A ranges at least from 9.5 μm to 10.5 μm, and wherein the transparent material of the insert includes a hybrid organo-sulfur polymer, which is cross-linked, including linear sulfur chains cross-linked by organic comonomers.

The invention relates to a glazing, in particular a windscreen, in a motor vehicle, of a train or of an airplane, associated with a thermal camera. The invention also discloses a device combining said glazing and said thermal camera for such displaying of information.

Vehicle glazings and the associated technology are constantly evolving, particularly for improving safety.

In particular, patent GB2271139 proposes a windscreen comprising a laminated glazing with, in a central portion and near the upper longitudinal edge, an opening filled by an insert made of material that is highly transparent to thermal infrared, more specifically made of zinc sulfide (ZnS) with transmission of at least 50% from 5 to 15 μm. A dedicated camera coupled to a screen visible to the driver is located in the passenger compartment facing the insert. The hole is circular and the insert is a disk bonded to the walls of the hole.

In manufacturing terms, the hole is manufactured before the windscreen glass goes through the autoclave.

Such a windscreen is not reliable enough, with the material proving to be fragile and difficult to shape, on an industrial scale (duration, scrapping rate). The invention aims to overcome this drawback.

More specifically, the present invention relates to a vehicle glazing (particularly laminated and/or curved), particularly for a motor vehicle (car, truck, public transport: bus, coach, etc.) or a rail vehicle (in particular with a maximum speed of at most 90 km/h or of at most 70 km/h, in particular subways, tramways), in particular a windscreen, or even a rear window, a side glazing (particularly having a subcentimetric thickness E1 of at most 5 mm for a motor vehicle windscreen), the glazing having a main external face (called F1) oriented toward the outside (of the vehicle) and a main (the most) internal face (called F4 if it is a laminated glazing or called F2) on the passenger compartment side
and the glazing comprising, preferably in a peripheral zone (preferably on the upper longitudinal edge and/or in a central region), a through-hole between the internal face and the external face, which hole is delimited by a side wall of the glazing, particularly a through-hole forming a peripheral notch or a closed hole (surrounded by the wall), in particular the equivalent diameter of the hole of at least 5 mm, and is better still is at most 5 cm or 3 cm (with a constant equivalent diameter or a larger equivalent diameter on the interior face than on the exterior face), particularly with a straight convex section, in particular circular or oval or ellipsoidal or even rectangular, square or hexagonal, the hole comprising (being filled by):
   an insert (flat or curved, with an exterior face flush with or set back from the external face F1, or even also with an interior face protruding, flush with or set back from the internal face F2, or respectively F4, for a laminated glazing) made of material that is transparent in a range A of wavelengths in the infrared spectrum beyond 2.5 μm (transparent to at least one wavelength in this range A), which insert has a given thickness E0, preferably at least millimetric, particularly preferably subcentimetric,
   and, preferably, between the insert and the side wall, attachment means for the insert (and also preferably for liquid or even gaseous water leak tightness), particularly in the form of a ring made of organic (or hybrid organic/inorganic) polymer and/or flexible material, for example, polycarbonate, or the insert is bonded to the side wall.

According to the invention the range A ranges from 9.5 μm to 10.5 μm, preferably from 8 to 12 μm or 13 μm or even 14 μm or 15 μm or 20 μm.

According to the invention, said transparent material of the insert comprises (and even preferably basically consists of) a hybrid organo-sulfur (co)polymer, which is cross-linked, comprising linear sulfur chains cross-linked by organic comonomers, particularly organometallic comonomers.

The transparent material of the insert may basically consist of said hybrid organo-sulfur polymer.

‘Substantially consists of’ is understood to mean that said hybrid polymer forms at least 85% by weight of said material of the insert, preferably at least 90% by weight and even 95% or 99% or 100% by weight.

The material of the insert may comprise one or more additive(s) preferably of at most 15% by weight or even of at most 10% or 5% or 1% by weight of said material.

For example, particles may be added, in particular nanoparticles, particularly mineral particles used for mechanical strengthening. These (nano)particles may be functionalized by a functional organic group (amine, thiol, hydroxyl, sulfonyl, etc.) promoting the interaction with the hybrid organo-sulfur polymer.

In one embodiment, the hybrid organo-sulfur polymer is obtained by radical copolymerization of sulfur in the molten state and of an organic comonomer (including organometallic) comprising C═C ethylene unsaturations. This copolymerization of sulfur and of organic comonomers, which allows a stable polymer to be provided, is often called inverse vulcanization. The hybrid sulfur polymer obtained by this copolymerization reaction is cross-linked, therefore thermoset, insoluble and infusible. The organic comonomers preferably represent a minority weight fraction of the resulting macromolecular network, i.e. of said cross-linked polymer. All or part of the organic comonomers act as a cross-linking agent bonding the polysulfur segments together.

The sulfur advantageously represents at least 50% by weight of said hybrid organo-sulfur polymer, preferably from 50 to 80% by weight of said hybrid organo-sulfur polymer, in particular from 55 to 79% by weight of said hybrid organo-sulfur polymer, and even from 60 to 78% by weight of said hybrid organo-sulfur polymer. The higher the sulfur content of the hybrid polymer, the higher the refractive index and the better its optical performances will be (greater transparency to LWIRs).

Beyond about 80% by weight of sulfur, the fraction of organic comonomers (cross-linking agent) becomes too low, such that the thermomechanical properties are not as good.

In order to form a cross-linked three-dimensional network, the organic comonomer can comprise at least two radically polymerizable unsaturations, for example, ethylene unsaturations (C═C double bonds) or oxirane type unsaturations (epoxide). A comonomer with a single polymerizable unsaturation, for example, a single C═C double bond, would lead to a linear, thermoplastic polymer with thermomechanical performances that are unsatisfactory and even incompatible with the use contemplated in the present application.

At least a fraction, preferably at least 80% by weight of the organic comonomers, in particular all the organic comonomers, preferably comprises three or four C═C double bonds or oxirane groups.

The material of the insert advantageously has a glass transition temperature that is at least equal to 50° C., preferably between 60° C. and 180° C. (limits included), in particular between 80° C. and 160° C. (limits included).

The hybrid organo-sulfur polymer may advantageously contain, in addition to sulfur, a smaller fraction of another element belonging to the group of chalcogens, preferably selenium (Se). The hybrid organo-sulfur polymer contains, for example, from 0.5 to 5% by weight of another element belonging to the group of chalcogens, which preferably is selenium (Se). The selenium fraction of the hybrid organo-sulfur polymer advantageously is from 0.5 to 10% by weight, preferably from 1.0 to 5% by weight.

In a preferred embodiment, at least a fraction of the organic comonomers, preferably the majority, in particular at least 80% or 90% by weight of the comonomers is selected from the group consisting of:
1,3-diisopropenylbenzene (DIB),
1,3,5-triisopropenylbenzene (TIB),
diiodobenzene, norbornadiene (NBD),
norbornadiene dimer (NBD2), and
tetravinyl tin (TVSn).

Hybrid organo-sulfur polymers according to the invention are described, for example, in the review article by Kleine et al. entitled “100th Anniversary of Macromolecular Science Viewpoint: High Refractive Index Polymers from Elemental Sulfur for Infrared Thermal Imaging and Optics”, ACS MacroLetters, 2020, 9, 245-259.

Manufacturing polymer by inverse vulcanization of sulfur and 1,3-diisopropenylbenzene (DIB) is described on page 249 in relation to FIG. 5. The polymerization of sulfur and of tetravinyl tin (TVSn) is described on page 252 in relation to FIG. 10. The synthesis of a hybrid (co)polymer of sulfur and of norbornadiene dimer (NBD2) is disclosed on page 253 and 254 in relation to FIG. 12.

Hybrid sulfur polymers according to the invention are also described in the review article by Kleine et al. entitled “Infrared Fingerprint Engineering: A Molecular-Design approach to Long Wave infrared transparency with polymeric materials”, Angew. Chem. (2019), 131, pages 1-6. Manufacturing an NBD2-based hybrid organo-sulfur copolymer by inverse vulcanization is described on page 3 in relation to FIG. 3.

Other methods exist for manufacturing hybrid organo-sulfur polymer which can be in particular a terpolymer or even a functionalized hybrid organo-sulfur (co)polymer. The hybrid organo-sulfur polymer, particularly obtained from a hybrid organo-sulfur prepolymer, therefore may be a terpolymer or a functionalized hybrid organo-sulfur polymer.

Application WO 2018/026493, incorporated by reference, describes a first method for manufacturing hybrid organo-sulfur polymer (terpolymer) based on a two-step reaction:
first step: forming a sulfur prepolymer by reacting elemental sulfur (liquid, molten) with a first vinyl comonomer (styrene, etc.) or with another unsaturated comonomer, miscible with the elemental sulfur, thereby allowing inverse vulcanization
second step: reacting sulfur prepolymer (liquid, molten) with at least one second comonomer miscible with the prepolymer,

The second comonomer can be multifunctional, which promotes its solubilization in the prepolymer and can provide a plurality of functional groups reacting with the prepolymer.

Various forms of elemental sulfur are described on page 3, paragraph 15.

A list of first styrene comonomers is provided on page 4, paragraph 17.

An example of a second comonomer is provided on page 2, paragraph 9, in particular alkynes or unsaturated/vinyl comonomers (preferably norbornenes, isobutylenes or styrenes, allyls, methacrylates, acrylates, acrylonitrile, vinylpyridines, maleimide.

An example of manufacturing a terpolymer is described in relation to FIGS. 2, 3 and 4.

Application WO2018/026493 also describes a method for manufacturing a functionalized hybrid organo-sulfur polymer comprising:
first step: manufacturing a first sulfur prepolymer from liquid elemental sulfur, particularly a styrene sulfur oligomer, miscible with the elemental sulfur, allowing inverse vulcanization
second step: thermal activation opening an S—S bond so as to incorporate at least one other unsaturated comonomer (particularly allyl, acrylate, styrene).

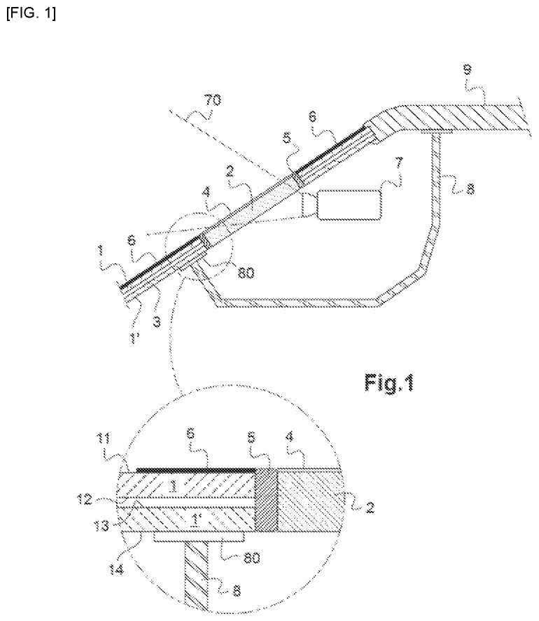

An example of elemental sulfur is provided on page 3, paragraph 15. An example of obtained polymer is described in FIG. 1.

A method for manufacturing hybrid organo-sulfur polymer (terpolymer) is described in application WO2015/123552, or in application US20180208686, incorporated by reference. This method also uses a two-step reaction:
first step: forming a sulfur prepolymer by reacting elemental sulfur with a first vinyl comonomer (styrene, etc.) or other unsaturated comonomer, which sulfur prepolymer further comprises another functional group, which preferably is a nucleophile group, particularly selected from among amine (—NH2), thiol, hydroxyl, nitro, in particular cited in paragraph 19
second step: reacting said other functional group with at least one second comonomer, particularly reacting by adding/substituting a nucleophile.

For example, when a second comonomer is an epoxide the reaction with the second comonomer causes the epoxide to open.

Illustrative examples are described in relation to FIGS. 7, 8, 14.

Furthermore, FIG. 16 shows, as an alternative to the radical route for obtaining sulfur prepolymer (in this case amine-functionalized), a route involving electrophilic aromatic substitution.

Infrared optical transmission is measured for the range A using a Fourier-transform spectrometer such as the BrukerVertex-70.

Preferably, the insert has infrared optical transmission of at least 35%, or better still at least 40%, 50% and better still at least 60% in this range A, particularly a variation in infrared optical transmission of at most 5% or 3% or 2% (flat spectrum) in the range A.

Preferably, the equivalent diameter of the hole (constant or variable in the thickness) and the equivalent diameter of the insert (constant or variable in the thickness) are each at most 5 cm, and even at most 3 cm, particularly of geometric shape, preferably with a straight convex section, particularly circular or oval or ellipsoidal or even rectangular, square or hexagonal.

An excessively big hole (and insert) may degrade the mechanical resistance of a glazing (windscreen, etc.) with consequences in terms of passenger safety.

Furthermore, the diameter of the insert is preferably at least 5 mm.

For greater transparency in the range A, the thickness E0 of the insert can be less than or equal to 10 mm (and even can be subcentimetric) and at least millimetric, particularly in a range ranging from 3 mm to 5 mm.

The insert can be curved. The material of the insert can be polished (exterior and interior face).

Advantageously, in order to improve its robustness, with the insert comprising an exterior face and an interior face, it comprises, on the exterior face and optionally on the interior face, at least one functional layer, particularly a mechanical and/or chemical protection layer.

The mechanical and/or chemical protection layer may be a monolayer or multilayer coating. The mechanical and/or chemical protection layer may be located directly on the exterior face, and particularly may be the only functional layer, or under an anti-reflection layer in the range A.

Advantageously, in order to improve the infrared transmission, with the insert comprising an exterior face and an interior face, it comprises, on the exterior face and/or on the interior face, an anti-reflection layer in the range A. The anti-reflection layer may be a monolayer or multilayer coating. The anti-reflection layer may be located directly on the interior face, and particularly can be the only functional layer.

In particular, the insert comprises the mechanical and/or chemical protection layer (directly) on the exterior face and the anti-reflection layer on the interior face.

The vehicle glazing (windscreen or other vehicle glazing, particularly a motor vehicle) can be monolithic, i.e. comprising a single glass sheet, which particularly is mineral or organic.

The vehicle glazing may comprise an organic glass sheet. Preferably, the organic glass is formed by a compound comprising acrylates, preferably by polymethyl methacrylate (PMMA). It also can be formed by polycarbonate.

The vehicle glazing can be a vehicle windscreen, but also can be a vehicle side window, a skylight, a vehicle rear window, for example, a heated rear window.

The glazing according to the invention may be a laminated glazing, particularly a vehicle windscreen (road vehicle, motor vehicle in particular), particularly curved, comprising a first glass sheet (mineral) with said main internal face, called F1, and an opposite main face (called F2) and a second glass sheet (mineral or even organic) with said main external face, called F4, on the inside of the passenger compartment (and the opposite main face F3), the first and second glass sheets being bonded by a lamination interlayer, particularly acoustic and/or tinted, made of a polymer material, particularly thermoplastic.

In particular, the laminated glazing comprises:
a first glass sheet (mineral), optionally clear, extra-clear or tinted, particularly gray or green, preferably curved, forming the exterior glazing, with first and second main faces, respectively called face F1 and face F2, in the case of a motor vehicle, that is preferably at most 2.5 mm thick, even at most 2 mm thick, particularly 1.9 mm, 1.8 mm, 1.6 mm and 1.4 mm thick, or even at most 1.3 mm thick or at most 1 mm thick
a lamination interlayer, optionally clear, extra-clear or tinted, particularly gray or green, made of a preferably thermoplastic polymeric material and better still of polyvinyl butyral (PVB), preferably, in the case of a motor vehicle, that is at most 1.8 mm thick, better still is at most 1.2 mm thick and even is at most 0.9 mm thick (and better still is at least 0.3 mm thick and even is at least 0.6 mm thick), particularly set back from the edge face of the first glazing by at most 2 mm and set back from the edge face of a second glazing by at most 2 mm, the lamination interlayer optionally having a transverse cross section tapering to a wedge-shape from the top to the bottom of the laminated glazing (particularly a windscreen),
a second glazing made of preferably curved and preferably clear or extra-clear or even tinted mineral glass forming the interior glazing, with third and fourth main faces, in the case of a motor vehicle, preferably thinner than the first glazing, even at most 2 mm thick, particularly 1.9 mm, 1.8 mm, 1.6 mm and 1.4 mm thick, or even at most 1.3 mm thick or at most 1 mm thick, with the thickness of the first and second glazings preferably being strictly less than 4 mm and even 3.7 mm.

The interior and/or exterior glass can be neutral (without coloration) or (slightly) tinted, particularly gray or green, such as the TSA glass from Saint-Gobain Glass. The interior and/or exterior glass may have undergone a chemical or heat treatment of the hardening or annealing type or may have undergone tempering (particularly in order to obtain better mechanical strength) or can be semi-tempered.

Without departing from the scope of the invention, the interlayer clearly can comprise several different types of laminations made of thermoplastic material, for example, with different hardnesses in order to provide an acoustic function, as described, for example, in publication U.S. Pat. No. 6,132,882, particularly a set of PVB laminations with different hardnesses. Similarly, one of the glass sheets can be thin compared to the thicknesses conventionally used.

According to the invention, the interlayer can have a wedge-shape, particularly in view of an HUD (Head Up Display) application. One of the laminations of the interlayer can also be batch-tinted.

As a common lamination interlayer, other than PVB, a flexible polyurethane PU, a thermoplastic without plasticizer such as ethylene-vinyl acetate copolymer (EVA), an ionomer resin can be cited. These plastics are, for example, between 0.2 mm and 1.1 mm thick, particularly 0.3 and 0.7 mm.

The lamination interlayer can comprise another functional plastic film (transparent, clear or tinted), for example, a polyethylene terephthalate PET film supporting a layer that is athermal, electroconductive, etc., for example, a PVB/functional film/PVB between the faces F2 and F3.

The transparent plastic film can have a thickness of between 10 and 100 μm. The transparent plastic film can more broadly be made of polyamide, polyester, polyolefin (PE: polyethylene, PP: polypropylene), polystyrene, polyvinyl chloride (PVC), polyethylene terephthalate (PET), poly(methyl methacrylate) (PMMA) or polycarbonate (PC). A clear film is preferred, in particular PET.

Use may be made for example of a clear coated PET film, for example XIR from Eastman, a coextruded PET/PMMA film, for example of the SRF 3M® type, but also numerous other films (for example made of PC, PE, PEN, PMMA, PVC), which are visually as transparent as possible and which are not modified, in the autoclave, as regards their surface and their consistency.

In order to limit heating in the passenger compartment or to limit the use of air conditioning, at least one of the glass sheets (preferably the exterior glass) is tinted, and the laminated glazing can also comprise a layer which reflects or absorbs solar radiation, preferably on face F4 or on face F2 or F3, in particular a transparent electrically conductive oxide layer, known as a TCO layer, (on face F4) or even a stack of thin layers comprising at least one TCO layer, or stacks of thin layers comprising at least one silver layer (on F2 or F3), the or each silver layer being arranged between dielectric layers.

The layer (silver) on face F2 and/or F3 and TCO layer on face F4 can be combined.

The TCO layer (of a transparent electrically conductive oxide) is preferably a layer of fluorine-doped tin oxide (SnO₂:F) or a layer of mixed indium tin oxide (ITO).

Naturally, the most desirable application is that the glazing be a windscreen for a road vehicle (automobile) or even for a rail vehicle (moderate speed).

The glazing according to the invention may comprise at least one first glass sheet comprising an opaque layer (for masking) on a main face, particularly an enamel (black, etc.) at the edge of the through-hole (so as to mask the camera(s), for example).

The laminated glazing according to the invention can comprise a first glass sheet comprising an opaque layer (for masking) on a main face (for example, face F2), particularly an enamel (black, etc.) at the edge of the through-hole (so as to mask the camera(s), for example) and/or a second glass sheet comprising an opaque layer (for masking) on a main face (for example, face F3 or F4), particularly an enamel (black, etc.) at the edge of the through-hole (so as to mask the camera(s), for example).

A masking layer may also be provided on at least one of the main faces of the lamination interlayer, particularly PVB.

The invention also relates to a device, which comprises:
the glazing as previously described
a camera, called thermal camera (sensitive in the range A), arranged in the passenger compartment behind said glazing in order to be able to receive radiation originating from outside the passenger compartment and that has passed through the insert, the thermal camera comprising an objective lens and a system for detecting infrared in the range A, for example, by microbolometry, particularly without cryogenic cooling,
Infrared detection is preferred with a maximum sensitivity in the range A and even with weak sensitivity above 20 μm or 15 μm or 14 μm and below 7 or 6 μm.

By way of an example of a thermal camera, the Atom® 1024 from Lynred USA can be cited.

Some advantageous but non-limiting embodiments of the present invention are described hereafter, which of course can be combined as appropriate.

FIG. 1 schematically shows a windscreen 100 according to the invention, as a cross section with a thermal camera 7 placed behind the windscreen facing a zone preferably located in the central and upper part of the windscreen. In this zone, the camera is oriented at a certain angle with respect to the surface of the windscreen (face F4). In particular, the objective lens and the infrared sensors are oriented directly toward the image capture zone, in a direction that is nearly parallel to the ground, i.e. only slightly inclined toward the road. In other words, the camera 7 is oriented toward the road at a slight angle with a field 70 adapted to fulfill its functions.

The windscreen is a conventional, particularly curved, laminated glazing, comprising:
an external glass sheet 1, preferably tinted, for example, made of TSA glass and 2.1 mm thick, with an exterior face F1 11 and an interior face F2 12; and
an internal glass sheet 1′, for example, made of TSA glass (or clear or extra-clear) and 2.1 mm thick or even 1.6 mm thick or even less, with an exterior face F3 13 and an interior face F4 14 on the passenger compartment side
the two glass sheets 1, 1′ being bonded to one another by an interlayer made of thermoplastic material 3, most often polyvinyl butyral (PVB), preferably clear, of submillimetric thickness optionally having a transverse cross section tapering to a wedge-shape from the top to the bottom of the laminated glazing, for example, a PVB (RC41 from Solutia or Eastman) that is approximately 0.76 mm thick, or, as a variant, if necessary, an acoustic PVB (three-layer or four-layer), for example, approximately 0.81 mm thick, for example, an interlayer in three PVB laminations.

In a conventional and well-known way, the windscreen is obtained by hot lamination of the elements 1, 1′ and 3.

The windscreen 100 comprises, on the exterior face 11, for example, (or preferably on F2 and/or on face F3 or F4 or even printed on the layer 3) an opaque coating, which is black 6, for example, such as a layer of enamel or black lacquer, over the entire surface of the glazing arranged facing the device incorporating the thermal camera (therefore, over the entire periphery of the hole), including the housing 8 thereof (plastic, metal, etc.), so as to conceal it. The housing 8 can be bonded to the face F4 by a glue 80 and to the roof 9.

The opaque layer 6 can extend beyond the zone with the insert. Optionally, the extension (lateral) of the opaque layer forms a strip at the upper edge of the through-hole so that the windscreen has an opaque (black) strip along the upper longitudinal edge, or even an opaque frame (black) over the entire periphery.

According to the invention, in the peripheral zone facing the camera, the windscreen comprises a through-hole between the internal face 14 and the external face 11, which hole is demarcated by a side wall 10 of the laminated glazing (glass 1/PVB 3/glass 1′), said through-hole comprising:
an insert 2 made of polymer material that is transparent in a range A of wavelengths in the infrared that ranges from at least 9.5 to 10.5 μm and preferably from 8 to 12 μm, even 15 μm or 20 μm, the insert having a given thickness E0 that preferably is less than or equal to 10 mm, for example, from 3 to 5 mm,
between the insert 2 and the side wall 10, attachment means for the insert, particularly in the form of a ring 5 made of a flexible material, polymer, the attachment means particularly being bonded to the side wall 10.

The material of the insert 2 has infrared transmission of at least 30%, and even better of at least 40% in said range A

The equivalent diameter of the hole is at most 5 cm and even at most 3 cm, the equivalent diameter of the insert is at most 5 cm, and even at most 3 cm.

The material of the insert 2 is a hybrid organo-sulfur polymer (with or without additives), for example, and is obtained by inverse vulcanization.

The insert 2 comprises an exterior face and an interior face and in this case it preferably comprises, on the exterior face (and optionally on the interior face), a mechanical and/or chemical protection layer 4 or even an anti-reflection layer. The interior face can comprise an anti-reflection layer.

The through-hole also can be a notch, therefore a through-hole preferably opening onto the roof side.

The through-hole (and the insert) can be in another region of the windscreen or even in another glazing of the vehicle, particularly a motor vehicle.

1. A vehicle glazing having a main external face to be oriented toward the outside and a main internal face to be oriented toward a passenger compartment side, the vehicle glazing comprising a through-hole between the internal face and the external face, which through-hole is delimited by a side wall of the vehicle glazing, said through-hole comprising an insert made of material that is transparent in a range A of wavelengths in the infrared spectrum beyond 2.5 μm,
wherein the range A ranges at least from 9.5 μm to 10.5 μm, and wherein said transparent material of the insert comprises a hybrid organo-sulfur polymer, which is cross-linked, comprising linear sulfur chains cross-linked by organic comonomers.

2. The vehicle glazing according to claim 1, wherein the sulfur represents at least 50% by weight of the hybrid organo-sulfur polymer.

3. The vehicle glazing according to claim 1, wherein at least a fraction of the organic comonomers comprise at least two C═C double bonds.

4. The vehicle glazing according to claim 1, wherein at least a fraction of the organic comonomers are selected from the group consisting of 1,3-diisopropenylbenzene (DIB), 1,3,5-triisopropenylbenzene (TIB), diiodobenzene, norbornadiene (NBD), norbornadiene dimer (NBD2), and tetravinyl tin (TVSn).

5. The vehicle glazing according to claim 1, wherein the hybrid organo-sulfur polymer contains from 0.5 to 5% by weight of another element belonging to the group of chalcogens.

6. The vehicle glazing according to claim 1, wherein the material of the insert has a glass transition temperature at least equal to 50° C.

7. The vehicle glazing according to claim 1, wherein the hybrid organo-sulfur polymer is obtained by inverse vulcanization.

8. The vehicle glazing according to claim 1, wherein the hybrid organo-sulfur polymer is a terpolymer or a functionalized hybrid organo-sulfur polymer.

9. The vehicle glazing according to claim 1, wherein the transparent material of the insert has infrared optical transmission of at least 35% in said range A.

10. The vehicle glazing according to claim 1, wherein the insert has a subcentimetric and at least millimetric thickness E0.

11. The vehicle glazing according to claim 1, wherein the insert comprises an exterior face and an interior face and comprises on the exterior face and/or on the interior face, at least one functional layer.

12. The vehicle glazing according to claim 1, further comprising, between the insert and the side wall, an attachment for the insert in the form of a ring made of flexible material and/or polymer, or wherein the insert is bonded to the side wall.

13. The vehicle glazing according to claim 1, wherein the vehicle glazing forms a laminated glazing comprising a first glass sheet with said internal face and an opposite face and a second glass sheet with said external face on the inside of the passenger compartment, the first and second glass sheets being bonded by a lamination interlayer.

14. The vehicle glazing according to claim 1, further comprising at least one first glass sheet comprising, on a main face, an opaque layer, at an edge of the through-hole.

15. A device, comprising:
said vehicle glazing according to claim 1, and
a thermal camera, arranged in the passenger compartment behind said vehicle glazing to receive radiation originating from outside the passenger compartment and that has passed through the insert, the thermal camera comprising an objective lens and a system for detecting infrared in the range A.

16. The vehicle glazing according to claim 1, wherein the vehicle glazing is a windscreen, a rear window, or a side glazing.

17. The vehicle glazing according to claim 1, wherein the range A ranges from 8 to 12 μm.

18. The vehicle glazing according to claim 2, wherein the sulfur represents from 50 to 80% by weight of the hybrid organo-sulfur polymer.

19. The vehicle glazing according to claim 3, wherein at least a fraction of the organic comonomers comprise three or four C═C double bonds.

20. The vehicle glazing according to claim 5, wherein the other element belonging to the group of chalcogens is selenium (Se).
